(19) United States
(12) Patent Application Publication
(10) Pub. No.: US 2019/0266922 A1
(43) Pub. Date: Aug. 29, 2019

(54) Active Cadaver Systems and Methods for Medical Simulations

(71) Applicants: Justin Michael Lemieux, Mountain View, CA (US); Gabriel Guimarães Rosa, Woodland, CA (US)

(72) Inventors: Justin Michael Lemieux, Mountain View, CA (US); Gabriel Guimarães Rosa, Woodland, CA (US)

(21) Appl. No.: 16/283,151

(22) Filed: Feb. 22, 2019

Related U.S. Application Data
(60) Provisional application No. 62/634,860, filed on Feb. 24, 2018.

(51) Int. Cl. G09B 23/30

(52) U.S. Cl. CPC G09B 23/303; G09B 23/306

(57) ABSTRACT

A medical simulation system for use with a cadaver is disclosed. The medical simulation system includes a reservoir that is configured to store and receive a perfusion solution adapted to inhibit clot formation in the cadaver, and a pump in communication with the reservoir that is configured to circulate the perfusion solution through the medical simulation system and the cadaver.

### CROSS-REFERENCE TO RELATED APPLICATIONS

This application claims the benefit of, and priority to, U.S. Provisional Patent Application Ser. No. 62/634,860, entitled “Restored Cadaveric Tissue Pulsatile Simulation Pump,” filed on Feb. 24, 2018, the entire content of which is hereby incorporated by reference.

### TECHNICAL FIELD

The present disclosure generally relates to systems and methods for performing simulated medical procedures and, more specifically, to the replication of cardiovascular functionality in cadaveric tissue.

### BACKGROUND

During medical and surgical education, training and instruction is generally performed on: a cadaver; a medical simulator (e.g., a mannequin or the like); or a live animal. Cadavers and medical simulators, however, are expensive, and do not provide trainees with realistic experience, and live animal training is not only controversial, but fraught with ethical and legal concerns.

The medical simulation systems described herein address these issues and concerns by providing a lower cost alternative to medical simulators that replicates cardiovascular functionality in a cadaver to reap the benefits of live animal training without the associated ethical and/or legal quagmires.

### SUMMARY

In one aspect of the present disclosure, a medical simulation system is disclosed for use with a cadaver. The medical simulation system includes a reservoir that is configured to store and receive a perfusion solution adapted to inhibit clot formation in the cadaver, and a pump in communication with the reservoir that is configured to circulate the perfusion solution through the medical simulation system and the cadaver.

In certain embodiments, the medical simulation system may further include a first valve that is positioned between the pump and the cadaver to regulate flow of the perfusion solution into the cadaver.

In certain embodiments, the first valve may be repositionable between an open position, in which the perfusion solution is flowable through the first valve and into the cadaver to simulate systolic pressure in the cadaver, and a closed position, in which flow of the perfusion solution through the first valve is blocked to simulate diastolic pressure in the cadaver.

In certain embodiments, the medical simulation system may further include a second valve that is positioned between the pump and the first valve. In such embodiments, the second valve may be configured to permit flow of the perfusion solution therethrough in a single direction only such that the perfusion solution is flowable from the reservoir through the second valve, and flow of the perfusion solution through the second valve towards the reservoir is inhibited.

In certain embodiments, the medical simulation system may further include an air circuit that is configured to vary the systolic pressure and the diastolic pressure simulated via repositioning of the first valve between the open position and the closed position.

In certain embodiments, the air circuit may include a first accumulator positioned between the pump and the first valve that is configured to receive and expel the perfusion solution to thereby alter the systolic pressure, and a second accumulator positioned between the first valve and the cadaver that is configured to receive and expel the perfusion solution to thereby alter the diastolic pressure.

In certain embodiments, the medical simulation system may further include a third valve positioned between the cadaver and the reservoir that is movable between a closed position, in which flow of the perfusion solution through the third valve is blocked to simulate central venous pressure, and an open position, in which the perfusion solution is flowable through the third valve to reduce the central venous pressure.

In certain embodiments, the third valve may be movable between discrete open and closed positions.

In certain embodiments, the third valve may be movable into at least one partially open position to modulate flow of the perfusion solution through the third valve, and thereby vary the central venous pressure. In such embodiments, the third valve may be configured for rotation between the closed position, the at least one partially open position, and the open position.

In certain embodiments, the medical simulation system may further include a fourth valve positioned between the third valve and the reservoir that is movable between discrete open and closed positions.

In another aspect of the present disclosure, a medical simulation system is disclosed for use with a cadaver. The medical simulation system includes an arterial circuit that is configured to simulate systolic and diastolic pressure in the cadaver, and a venous circuit that is configured to simulate central venous pressure in the cadaver. The arterial circuit includes: a reservoir that is configured to store and receive a perfusion solution adapted to inhibit clot formation in the cadaver; a pump in communication with the reservoir that is configured to circulate the perfusion solution through the medical simulation system and the cadaver; and a first valve positioned between the pump and the cadaver to regulate flow of the perfusion solution into the cadaver. The first valve is repositionable between open and closed positions to simulate systolic and diastolic pressure in the cadaver. The venous circuit includes a second valve positioned between the cadaver and the reservoir that is movable between a closed position, in which flow of the perfusion solution through the second valve is blocked to increase pressure between the cadaver and the second valve and thereby simulate central venous pressure in the cadaver, and an open position, in which the perfusion solution is flowable through the second valve to reduce the central venous pressure.

In certain embodiments, the first valve may be movable between discrete open and closed positions.

In certain embodiments, the second valve may be movable between discrete open and closed positions.

In certain embodiments, the second valve may be movable into at least one partially open position to modulate flow of the perfusion solution through the second valve, and thereby vary the central venous pressure. In such embodiments, the second valve may be configured for rotation between the closed position, the at least one partially open position, and the open position.

In certain embodiments, the medical simulation system may further include a third valve positioned between the second valve and the reservoir that is movable between discrete open and closed positions.

In another aspect of the present disclosure, a method of replicating cardiovascular functionality in a cadaver is disclosed. The method includes using a pump to circulate a perfusion solution, which is adapted to inhibit clot formation in the cadaver, through a closed circuit such that the perfusion solution flows from a reservoir into the cadaver, and from the cadaver into the reservoir.

In certain embodiments, the method may further include opening and closing a first valve positioned between the pump and the cadaver to simulate systolic pressure and diastolic pressure in the cadaver.

In certain embodiments, the method may further include varying the systolic pressure via communication of the perfusion solution into and/or out of a first accumulator positioned between the pump and the first valve, and varying the diastolic pressure via communication of the perfusion solution into and/or out of a second accumulator positioned between the first valve and the cadaver.

In certain embodiments, the method may further include opening and closing a second valve positioned between the cadaver and the reservoir to simulate central venous pressure in the cadaver.

### BRIEF DESCRIPTION OF THE DRAWINGS

According to common practice, the various features of the drawings may not be to scale, and may be arbitrarily expanded or reduced for clarity.

FIG. 1 is a schematic illustration of one embodiment of a medical simulation system that is configured and adapted to replicate cardiovascular physiology in a cadaver.

FIG. 2 is a schematic illustration of an alternate embodiment of the system seen in FIG. 2, which further includes a valve, pressure sensors, and a flow meter.

FIG. 3 illustrates a square wave pattern representing flow through the valve seen in FIG. 2 in one implementation of the system.

FIG. 4 illustrates a sinusoidal wave pattern representing flow through the valve seen in FIG. 2 in an alternate implementation of the system.

FIG. 5 is a schematic illustration of an alternate embodiment of the system seen in FIG. 2, which further includes an air circuit.

FIG. 6 is a schematic illustration of an alternate embodiment of the system seen in FIG. 5, which further includes a venous circuit.

FIG. 7 is a schematic illustration of an alternate embodiment of the system seen in FIG. 2 including the venous circuit seen in FIG. 6.

FIG. 8 illustrates a method of preparing the cadaver for use with the presently disclosed system.

### DETAILED DESCRIPTION

The present disclosure describes various systems and methods for replicating cardiovascular functionality in a cadaver (e.g., for the purpose of training and/or educating medical professionals), as well as various methods of preparing a cadaver for use with the systems. The systems described herein are configured to circulate a clot-inhibiting perfusion solution through a closed circuit that includes a reservoir, a pump (e.g., a centrifugal pump), and a valve (e.g., a solenoid) such that the perfusion solution is pumped from the reservoir, through the valve, to the cadaver. The valve is repositionable between open and closed positions to simulate diastolic pressure (i.e., when the valve is closed) and systolic pressure (i.e., when the valve is open) in the cadaver.

To vary the diastolic and/or systolic pressure in the cadaver, in certain embodiments, the system may also incorporate an air circuit including first and second accumulators (e.g., charged gas (air) units) that are positioned on opposite sides (i.e., upstream and downstream) of the valve. For example, in certain implementations, the first (upstream) accumulator may be used to increase the systolic pressure by increasing the volume of perfusion solution flowing through the valve, and the second (downstream) accumulator may be used to decrease the diastolic pressure by diverting the flow of perfusion solution away from the cadaver.

The system may also include one or more valves (e.g., a rotatable ball valve and/or a solenoid) positioned between the cadaver and the reservoir. In such embodiments, by opening and closing the valve(s), pressure can be created downstream of the cadaver to simulate central venous pressure.

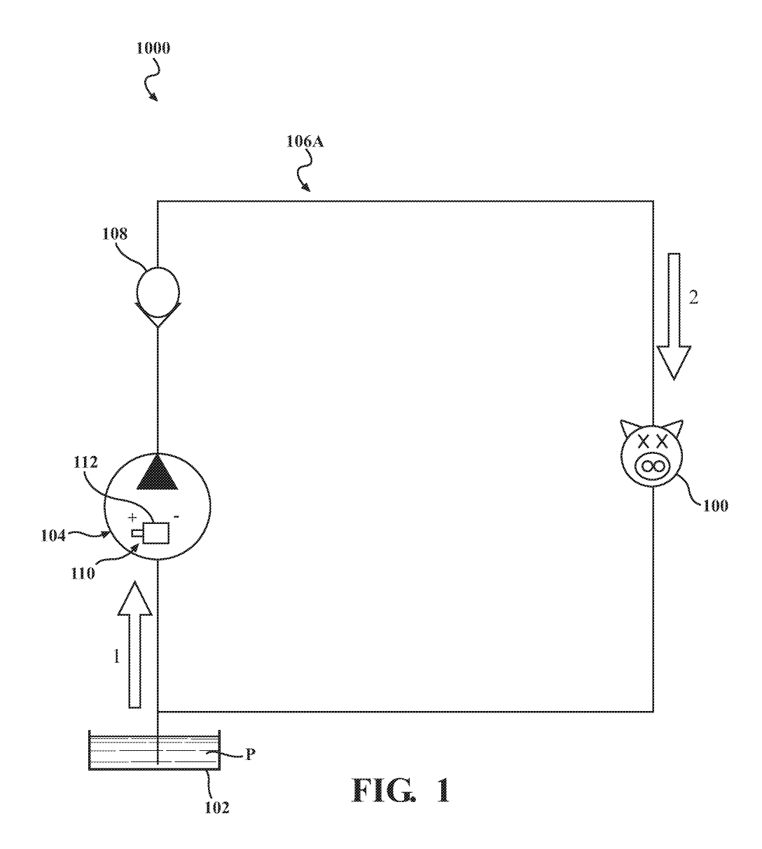

FIGS. 1-7 illustrate various embodiments and implementations of a medical simulation and pulsatile flow bypass system 1000 that is configured and adapted to replicate cardiovascular physiology in cadaveric tissue (e.g., during the training and/or education of medical professionals). The system 1000 is connectable to a cadaver 100 through its major arteries (e.g., the aorta and the inferior vena cava) to simulate functionality of the heart and the circulatory system. Although the cadaver 100 is generally depicted as a pig, it should be understood that the system 1000, and the methods described herein, may be applied to other animal cadavers (e.g., pigs, goats, sheep, dogs, cats, etc.), as well as to human cadavers, in alternate implementations of the present disclosure.

In the embodiment seen in FIG. 1, the system 1000 includes a reservoir 102 that is configured to accommodate a perfusion solution P, and a pump 104 that is in communication with the reservoir 102 so as to form an arterial circuit 106A that communicates the perfusion solution P from the reservoir to the cadaver 100. The system 1000 operates as a closed circuit in that the pump circulates the perfusion solution P from the reservoir 102, through the various components of the system 1000, to the cadaver 100, and then returns the perfusion solution P to the reservoir 102. It is envisioned that the system 1000 may operate at a flow rate that is substantially within the range of approximately 0 mL/second to approximately 150 mL/second, and that the response rate on altering the flow rate may be substantially within the range of approximately 0 seconds to approximately 2 seconds (e.g., so as to approximate animal and human physiology). It should be appreciated, however, that flow rates and response rates outside these ranges would not be beyond the scope of the present disclosure.

The reservoir 102 may be configured to accommodate any necessary or desirable volume of the perfusion solution P at (or near) body temperature (e.g., 30° C. to 40° C.), and may include (e.g., may be formed from) any suitable material or combination of materials. Although the reservoir 102 is contemplated as having a volume of approximately 30 L to 50 L (e.g., 40 L), volumes outside of this range would not be beyond the scope of the present disclosure.

The perfusion solution P is adapted to deliver nutrients to the tissues of the cadaver 100 (e.g., to keep the tissues alive), and may create oncotic pressure to guard against saturation and/or bloating of the tissues. In various embodiments of the disclosure, the perfusion solution P may also be adapted to inhibit (if not entirely prevent) clotting in the cadaver 100, and to replicate the look and/or feel of blood, although the viscosity of the perfusion solution P may be varied to achieve any desirable result in various implementations of the present disclosure.

In one particular embodiment, the perfusion solution P includes: approximately 1.5 cups of salt; approximately 4 tabs (e.g., approximately 3 g to approximately 7 g) of potassium chloride; approximately ⅓ cup of corn syrup; approximately 3 bottles (e.g., approximately 1000 g to approximately 2000 g) of chocolate syrup; approximately 1 bottle (e.g., approximately 20 g to approximately 40 g) of vanilla; approximately 5 tabs (e.g., approximately 50 g to approximately 75 g) of vitamin C; approximately 2 bottles (e.g., approximately 5 g to approximately 20 g) of magnesium citrate; approximately 2 bottles (e.g., approximately 100 mL to approximately 300 mL) of red dye; approximately ⅓ cup of baking soda; approximately 12 packets (e.g., approximately 300 g to approximately 500 g) of gelatin; and approximately 1 bottle (e.g., approximately 50 mL to approximately 150 mL) of blue dye. It should be appreciated, however, that the ingredients and/or quantities described herein may be altered in additional embodiments of the present disclosure so as to vary the consistency, color, etc., of the perfusion solution P and achieve any desired result. To assemble the perfusion solution P, each of the ingredients is mixed into boiling water, with the baking soda and the gelatin being added gradually, the mixture is continuously stirred, and additional water (e.g., approximately 15 L to approximately 25 L) is added until the desired consistency is achieved.

With continued reference to FIG. 1, the pump 104 may be configured as any structure, mechanism, machine, or the like suitable for the intended purpose of drawing the perfusion solution P from the reservoir 102, circulating the perfusion solution P through the various components of the system 1000 to the cadaver 100 (in the direction indicated by arrow 1), and returning the perfusion solution P to the reservoir 102. To inhibit (if not entirely prevent) backflow of the perfusion solution P into the pump 104 (i.e., flow of the perfusion solution P in the direction indicated by arrow 2), it is envisioned that the system 1000 may include a unidirectional check valve 108. May be used in certain embodiments, but not others.

In various embodiments of the disclosure, it is envisioned that the pump 104 may be configured for manual operation (e.g., as a hand pump) or, alternatively, that the pump 104 may be mechanized. For example, as illustrated in FIG. 1, the pump 104 may be configured as centrifugal pump. In such embodiments, it is envisioned that the pump 104 may include an internal power source 110, as seen in FIG. 1, or, alternatively, that the power source 110 may be located externally of the pump 104. Although generally illustrated as a battery 112, it should be appreciated that alternate configurations for the power source 110 (such as a generator, for example) are also contemplated herein.

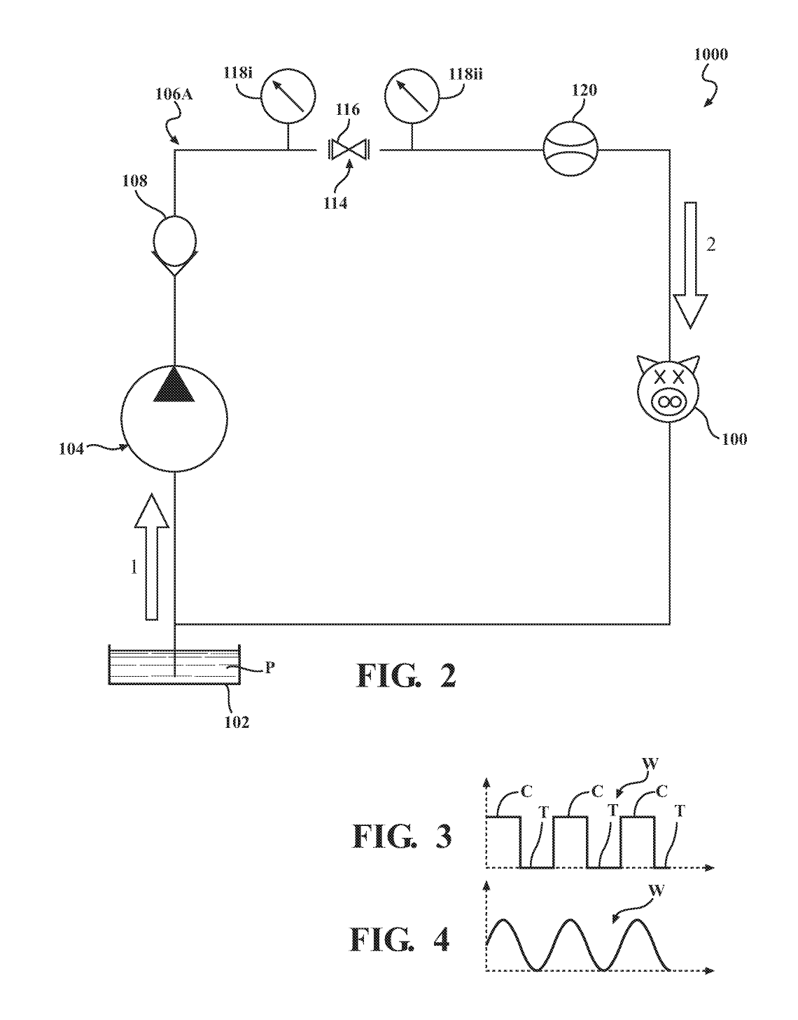

With reference now to FIG. 2, in certain embodiments, the system 1000 may further include a valve 114 (e.g., a solenoid valve 116) located between the pump 104 and the cadaver 100 (i.e., downstream of the check valve 108). The valve 114 is repositionable between discrete (first and second) open and closed positions (i.e., such that the valve 114 is either fully open or fully closed) so as to vary the flow of perfusion solution P to the cadaver 100, and thereby simulate a heartbeat, as well as diastolic and systolic pressure in the cadaver 100, as described in further detail below. By varying the speed with which the valve 114 cycles between the open and closed positions, the stroke volume (i.e., the volume of perfusion solution P that passes through the valve 114 during a cycle) can be similarly varied.

When the valve 114 is in the closed position, flow of the perfusion solution P to the cadaver 100 through the valve 114 is prevented, which reduces the volume of perfusion solution P present in the cadaver 100 (as the perfusion solution P drains from the cadaver 100 and returns to the reservoir 102), thereby simulating diastolic pressure. By contrast, when the valve 114 is in the open position, the perfusion solution P flows through the valve 114 and into the cadaver 100, thereby increasing the volume of perfusion solution P present in the cadaver 100, and simulating systolic pressure. In various implementations of the system 1000, it is envisioned that flow of the perfusion solution P, and the resultant diastolic and systolic pressure in the cadaver 100, may be altered by varying the power output of the pump 104.

As seen in FIG. 1, the system 1000 may include one more sensors 118 to measure and/or monitor operation of the system 1000. For example, in the embodiment seen in FIG. 2, the system 1000 includes a pair of pressure sensors (e.g., transducers) 118i, 118ii positioned downstream and upstream of the valve 114, respectively, to measure the systolic and diastolic pressure within the system 1000, and facilitate various calculations, including, for example, mean arterial pressure (which is generally weighted 2/3 diastolic to 1/3 systolic). Additionally, or alternatively, the system 1000 may include a flow meter 120 that is positioned downstream of the valve 114 and upstream of the cadaver 100 to measure flow of the perfusion solution P into the cadaver 100.

As the valve 114 cycles between the open and closed positions, the systolic and diastolic pressure within the cadaver 100 increases and decreases in a square wave pattern W, as seen in FIG. 3. For example, when the valve 114 is moved into the open position, the systolic pressure in the cadaver 100 is increased, which is represented as crests C in the wave W, and when the valve 114 is moved into the closed position, the diastolic pressure in the cadaver 100 is decreased, which is represented as troughs T in the wave W.

It is envisioned that the valve 114 be moved between the open and closed positions according to any desired frequency. For example, the valve 114 may operate at a frequency within the range of approximately 0 Hz to approximately 4 Hz (e.g., to simulate approximately 240 beats per minute). Additionally, it is envisioned that the various components of the system 1000 may be configured and arranged to achieve any desired pressure during operation. For example, in certain implementations, it is envisioned that the system 1000 may operate substantially within the range of approximately 50 mmHg (1 p.s.i.) (i.e., at the troughs T in the wave W) to approximately 500 mmHg (10 p.s.i.) (i.e., at the crests C in the wave W), and that the response rate on altering the pressure within the system 1000 may be substantially within the range of approximately 0 seconds to approximately 2 seconds so as to approximate animal and human physiology, although pressures and response rates outside these ranges would not be beyond the scope of the present disclosure.

During operation of the system 1000, by varying the frequency with which the valve 114 opens and closes, the number of “heartbeats” per minute (e.g., the pulse rate in the cadaver 100) can be varied to simulate normal functionality, tachycardia, etc. Additional medical conditions can also be simulated by varying the period of the wave W (i.e., the amounts of time for which the valve 114 is in the open and closed positions, which are represented by the lengths of the crests C and the troughs T of the wave W, respectively). For example, in certain implementations, it is envisioned that the timing of the valve 114 may be altered so as to deviate from the 2/3:1/3 (ratio of normal cardiac contraction).

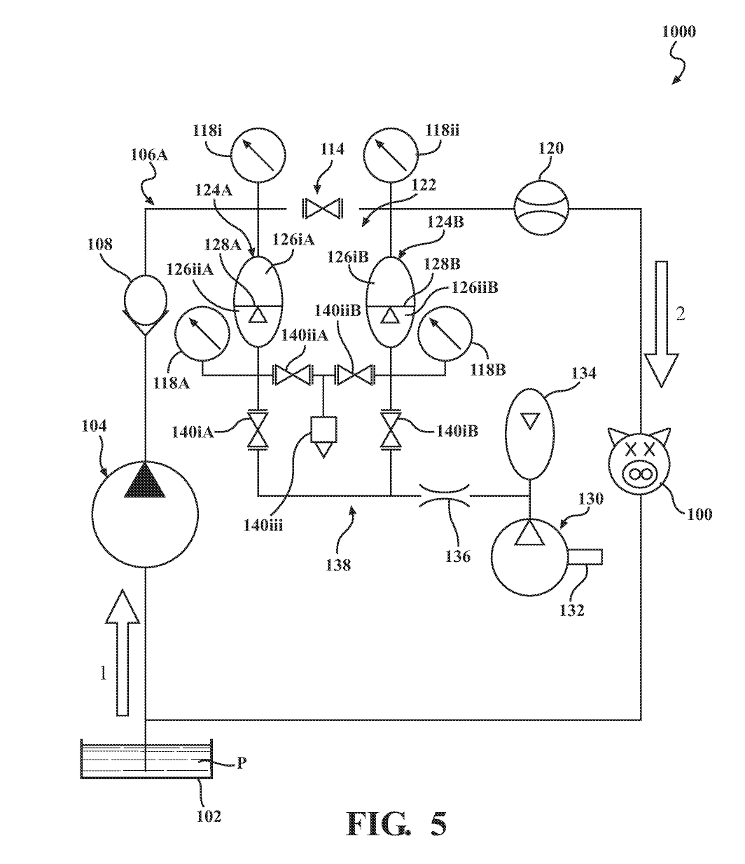

In certain embodiments of the disclosure, it is envisioned that the valve 114 may be configured for positioning in one or more partially open positions (i.e., one or more positions between the fully open and fully closed positions mentioned above) to allow for additional control over the flow of the perfusion solution P through the valve 114 and, thus, variation in the systolic and diastolic pressure in the cadaver 100. In such embodiments, increases and decreases in the systolic and diastolic pressure may be more gradual such that the pattern of the wave W representing fluctuations in the systolic and diastolic pressure is more sinusoidal, as seen in FIG. 4. Alternatively, it is envisioned that the square wave pattern representing functionality of the valve 114 (and corresponding fluctuations in the systolic and diastolic pressure in the cadaver 100) may be varied via the inclusion of an air circuit 122 (FIG. 5).

The air circuit 122 includes (first and second) accumulators 124A, 124B that are configured and positioned to vary the (diastolic and systolic) pressure in the cadaver 100 by increasing and decreasing the volume of perfusion solution P flowing through the system 1000, as described in detail below. By varying the volume of perfusion solution P flowing through the system 1000, the square wave seen in FIG. 3 can be modulated (“softened”) to achieve a more sinusoidal pattern similar to that seen in FIG. 4.

The accumulators 124A, 124B are configured as charged gas (e.g., air) units, and are positioned on opposite sides of the valve 114 (i.e., the accumulator 124A is positioned upstream of the valve 114, and the accumulator 124B is positioned downstream of the valve 114). The accumulator 124A includes a (first) chamber 126iA that is configured to receive and store a volume of the perfusion solution P, and a (second) chamber 126iiA that is configured to receive and store pressurized gas. Similarly, the accumulator 124B includes a first chamber 126iB that is configured to receive and store a volume of the perfusion solution P, and a second chamber 126iiB that is configured to receive and store pressurized gas. The chambers 126iA, 126iiA in the accumulator 124A are separated by a divider 128A, and the chambers 126iB, 126iiB in the accumulator 124B are separated by a divider 128B. The dividers 128A, 128B separate the perfusion solution P from the pressurized gas contained in the accumulators 124A, 124B so as to prevent contamination, and may include any structure suitable for this intended purpose, such as, for example, a membrane, a ball, etc.

In certain embodiments, it is envisioned that the accumulators 124A, 124B may be identical in configuration. Alternatively, however, it is envisioned that the accumulators 124A, 124B may be dissimilar. For example, it is envisioned that capacities of the chambers 126iA, 126iiA in the accumulator 124A may vary from those of the chambers 126iB, 126iiB in the accumulator 124B.

As the volume of pressurized gas in the chamber 126iiA is increased, pressure is applied to the divider 128A, which reduces the available volume in the chamber 126iA and, thus, the amount of perfusion solution P that can be contained in the chamber 126iA. Conversely, as the volume of pressurized gas in the chamber 126iiA is decreased, the pressure applied to the divider 128A is reduced, which increases the available volume in the chamber 126iA and, thus, the amount of perfusion solution P that can be contained in the chamber 126iA. Likewise, as the volume of pressurized gas in the chamber 126iiB is increased, pressure is applied to the divider 128B, which reduces the available volume in the chamber 126iB and, thus, the amount of perfusion solution P that can be contained in the chamber 126iB. Conversely, as the volume of pressurized gas in the chamber 126iiB is decreased, the pressure applied to the divider 128B is reduced, which increases the available volume in the chamber 126iB and, thus, the amount of perfusion solution P that can be contained in the chamber 126iB.

The air circuit 122 further includes a compressor 130 that is configured to pressurize ambient air received through an inlet 132. Once pressurized, the air is fed into the chambers 126iiA, 126iiB of the accumulators 124A, 124B, respectively. Alternatively, in certain embodiments, it is envisioned that pressurized air from the compressor 130 may be stored within a tank 134 (or other such suitable receptacle), and that the accumulators 124A, 124B may be fed by pressurized air from the tank 134. To control the flow of pressurized air into the accumulators 124A, 124B, in certain embodiments, the air circuit 122 may also include a pressure regulator 136, as seen in FIG. 5.

As indicated above, during operation of the air circuit 122, the accumulators 124A, 124B may be utilized to alter the flow of perfusion solution P into the cadaver 100 to thereby vary the systolic and diastolic pressure in the cadaver 100. For example, when the valve 114 is moved into the closed position, in order to moderate the rate at which flow into the cadaver 100 is reduced, perfusion solution P can be purged from the chamber 126iB of the accumulator 124B to offset the interruption of flow through the valve 114, and thereby “soften” the descending sections of the wave W (FIGS. 3, 4). Contemporaneously, flow of the perfusion solution P from the pump 104 may be diverted into the chamber 126iA of the accumulator 124A to fill the chamber 126iA. When the valve 114 is moved into the open position, however, as flow of the perfusion solution P through the valve 114 is restored, a portion of the perfusion solution P flowing through the valve 114 may be diverted into the chamber 126iB of the second accumulator 124B to offset the increase in flow through the valve 114, and thereby “soften” the ascending sections of the wave W (FIGS. 3, 4).

Additionally, it is envisioned that the accumulators 124A, 124B may also be used to increase (spike) the systolic pressure in the cadaver 100. More specifically, when the valve 114 is in the open position, the chamber 126iA of the accumulator 124A can be purged, and the perfusion solution P expelled therefrom can be directed through the valve 114 to supplement the flow from the pump 104 to further increase (spike) the systolic pressure in the cadaver 100.

By varying the volume of pressurized air in the accumulators 124A, 124B (i.e., within the chambers 126iiA, 126iiB), the systolic and diastolic pressures in the cadaver 100 can be adjusted to achieve any desired result. More specifically, with respect to the accumulator 124A, when the valve 114 is open, increasing and decreasing the pressure within the chamber 126iiA causes corresponding increases and decreases in the amount of perfusion solution P that is purged from the chamber 126iA and, thus, the volume of perfusion solution P flowing into the cadaver 100, and the systolic pressure. In certain implementations, it is envisioned that the systolic pressure may be further increased via the accumulator 124B. More specifically, by increasing the air pressure within the chamber 126iiB while the valve 114 is open, perfusion solution P can also be purged from the chamber 126iB to further supplement the flow of perfusion solution P into the cadaver 100, and further increase the systolic pressure.

With respect to the accumulator 124B, when the valve 114 is closed, increasing and decreasing the pressure within the chamber 126iiB causes corresponding increases and decreases in the volume of perfusion solution P that is diverted into the chamber 126iB (and away from the cadaver 100) and, thus, the diastolic pressure. More specifically, increasing the pressure within the chamber 126iiB reduces the available volume in the chamber 126iB, thus reducing the volume of perfusion solution P that can be diverted away from the cadaver 100, and increasing the diastolic pressure, whereas decreasing the pressure within the chamber 126iiB increases the available volume in the chamber 126iB, thus increasing the volume of perfusion solution P that can be diverted away from the cadaver 100, and decreasing the diastolic pressure.

The air circuit 122 thus facilitates manipulation and control over the systolic and diastolic pressures in the cadaver 100, as well as the pulse pressure (i.e., the difference between the systolic and diastolic pressures), to allow for the simulation of a variety of medical conditions such as, for example, hemorrhaging.

In certain embodiments, the air circuit 122 may include one or more pressure sensors 118 (e.g., transducers). For example, in the embodiment seen in FIG. 5, the air circuit 122 includes first and second pressure sensors 118A, 118B to measure and/or monitor the pressure within the accumulators 124A, 124B, respectively.

It is also envisioned that the air circuit 122 may include a valve system 138 to regulate pressure within the accumulators 124A, 124B. For example, in the embodiment seen in FIG. 5, the valve system 138 includes valves 140iA, 140iiA (e.g., solenoids) that facilitate adjustment of, and control over, the pressure within the accumulator 124A, and valves 140iB, 140iiB (e.g., solenoids) that facilitate adjustment of, and control over, the pressure within the accumulator 124B. The valve system 138 also includes an exhaust (relief) valve 140iii through which pressurized air may be purged to relieve pressure in the accumulators 124A, 124B, as described below.

During use of the air circuit 122, with respect to the accumulator 124A, when the valve 140iA is open, pressurized air flows into the chamber 126iiA (e.g., from the tank 134). When the valve 140iA is closed, however, and the valve 140iiA is opened, pressurized air flows out of the accumulator 124A, through the valve 140iiA, and exits the system through the exhaust valve 140iii. With respect to the accumulator 124B, when the valve 140iB is open, pressurized air flows into the chamber 126iiB (e.g., from the tank 134). When the valve 140iB is closed, however, and the valve 140iiB is opened, pressurized air flows out of the accumulator 124B, through the valve 140iiB, and exits the system through the exhaust valve 140iii.

Via the valve system 138, the accumulators 124A, 124B are each operational in four modes. More specifically, with respect to the accumulator 124A, in a first mode, the valves 140iA, 140iiA are both open, which allows pressurized air to flow from the tank 134, through the valves 140iA, 140iiA, and through the exhaust valve 140iii (e.g., for purging during preparation and/or cleanup of the system 1000). In a second mode, each of the valves 140iA, 140iiA is closed, during which time the branch of the valve system 138 in communication with the accumulator 124A is idle. In a third mode, the valve 140iA is open and the valve 140iiA is closed, which allows the accumulator 124A to be pressurized by allowing for the flow of pressurized gas into the chamber 126iiA (e.g., from the tank 134). In a fourth mode, the valve 140iA is closed and the valve 140iiA is open, which allows the accumulator 124A to be depressurized via the communication of pressurized gas from the chamber 126iiA through the exhaust valve 140iii.

Likewise, with respect to the accumulator 124B, in a first mode, the valves 140iB, 140iiB are both open, which allows pressurized air to flow from the tank 134, through the valves 140iB, 140iiB, and through the exhaust valve 140iii (e.g., for purging during preparation and/or cleanup of the system 1000). In a second mode, each of the valves 140iB, 140iiB is closed, during which time the branch of the valve system 138 in communication with the accumulator 124B is idle. In a third mode, the valve 140iB is open and the valve 140iiB is closed, which allows the accumulator 124B to be pressurized by allowing for the flow of pressurized gas into the chamber 126iiB (e.g., from the tank 134). In a fourth mode, the valve 140iB is closed and the valve 140iiB is open, which allows the accumulator 124B to be depressurized via the communication of pressurized gas from the chamber 126iiB through the exhaust valve 140iii.

By varying which of the valves 140 are opened and closed, the pressures in the accumulators 124A, 124B can be varied, either individually or simultaneously, thus further facilitating control over the systolic and diastolic pressures in the cadaver 100.

In various methods of operation, it is envisioned that the accumulators 124A, 124B may be operated either individually or simultaneously. Additionally, it is envisioned that the air circuit 122 may be operated in either passive or active states. In the passive state, the compressor 130 and the valve system 138 are each inactive, and the accumulators 124A, 124B function in the manner described above. In the active state, however, the accumulators 124A, 124B, the compressor 130, and the valve system 138 may function simultaneously, which allows the effects of the accumulators 124A, 124B to be exaggerated. For example, in the active state, the systolic pressure can be increased significantly (spiked) by increasing the pressure within the chamber 126iiA of the accumulator 124A (and/or the chamber 126iiB of the accumulator 124B) to further increase the volume of perfusion solution P flowing through the valve 114 into the cadaver 100, and the diastolic pressure can be decreased significantly by purging pressurized gas from the chamber 126iiB of the accumulator 124B (e.g., by opening the valve 140iiB) to increase the available volume in the chamber 126iB and, thus, the amount of perfusion solution P that is diverted away from the cadaver 100.

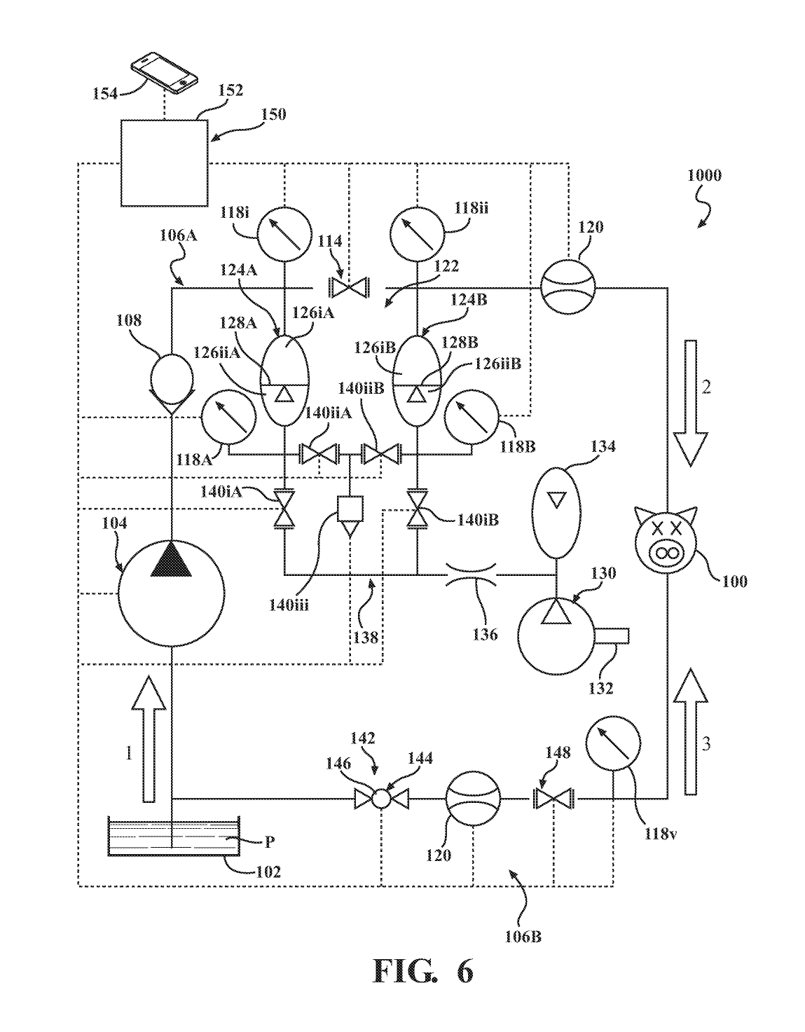

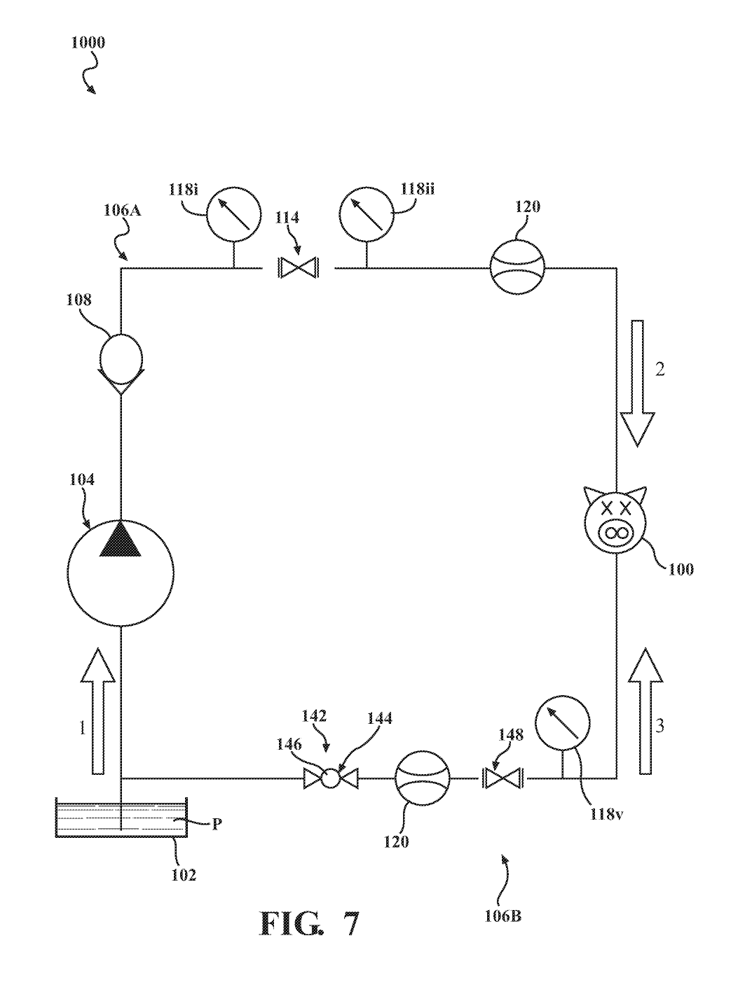

With reference now to FIG. 6, in certain embodiments, the system 1000 may further include an (optional) venous circuit 106B that is positioned between the cadaver 100 and the reservoir 102 such that perfusion solution P enters the venous circuit 106B after exiting the cadaver 100 (rather than returning directly to the reservoir 102). Although shown as supplementing the air circuit 122 in the embodiment illustrated in FIG. 6, embodiments are also contemplated herein in which the air circuit 122 may be omitted, as illustrated in FIG. 7.

The venous circuit 106B is configured to simulate central venous pressure within the cadaver 100 by creating backpressure in the system 1000 (i.e., in the direction indicated by arrow 3), and includes a (first) valve 142 that is repositionable between open and closed positions. When the valve 142 is in the open position, the perfusion solution P exiting the cadaver 100 is allowed to flow therethrough into the reservoir 102. When the valve 142 is in the closed position, however, the flow of perfusion solution P into the reservoir 102 is inhibited (if not entirely prevented), which creates pressure between the valve 142 and the cadaver 100 (in the direction indicated by arrow 3) that simulates central venous pressure in the cadaver 100.

In the illustrated embodiment, the valve 142 includes a rotatable internal valve member 144 (e.g., an apertured ball valve 146). As the internal valve member 144 rotates, the valve 142 is repositioned between a fully open position, a fully closed position, and one or more partially open positions to thereby proportionally vary the volume of perfusion solution P flowing through the valve 142 (i.e., as the aperture in the ball valve 146 is gradually exposed and concealed), and adjust the central venous pressure upstream of the valve 142. More specifically, as the internal valve member 144 rotates from the open position, through the partially open positions, and to the closed position, the central venous pressure is proportionally increased, and as the internal valve member 144 rotates from the closed position, through the partially open positions, and to the open position, a low-pressure zone is created that pulls perfusion solution P from the cadaver 100, thereby proportionally reducing the central venous pressure. To measure flow of the perfusion solution P from the cadaver 100, in certain embodiments, it is envisioned that the venous circuit 106B may include an additional pressure sensor 118V and/or an additional flow meter 120 positioned upstream of the valve 142, as seen in FIGS. 6 and 7.

In certain embodiments, it is envisioned that the valve 142 may define a period (i.e., the time required for the internal valve member 144 to rotate between the open and closed positions) that lies substantially within the range of approximately 20 seconds to approximately 45 seconds (e.g., 30 seconds). To allow for more immediate fluctuations (e.g., spikes) in the central venous pressure, the venous circuit 106B may further include a (second) valve 148 (e.g., a solenoid) that is repositionable between discrete open and closed positions (i.e., such that the valve 148 is either fully open or fully closed) to reduce the amount of time required to create the desired (central venous) pressure between the cadaver 100 and the venous circuit 106B.

When used in conjunction with the arterial circuit 106A (as illustrated in FIGS. 6 and 7), the valves 142, 148 function in anti-phase to the valve 114. More specifically, when the valve 114 is in the open position, the valve 142 (and/or the valve 148) is moved into the closed position, and when the valve 114 is in the closed position, the valve 142 (and/or the valve 148) is moved into the open position. By operating in anti-phase, the system 1000 guards against the creation of excessive central venous pressure (which may otherwise occur were the valve 114 and the valve 142 (and/or the valve 148) each closed), as well as the creation of insufficient diastolic and central venous pressures (which may otherwise occur were the valve 114 and the valve 142 (and/or the valve 148) each open).

In an additional embodiment of the disclosure, it is envisioned that the valves 142, 148 may be replaced by a proportional valve (e.g., a solenoid) that is moveable between a series of partially open positions to thereby allow for further variation and control over the central venous pressure.

In certain embodiments, it is envisioned that operation of the system 1000 may be governed and/or regulated by a control system 150 including a central processor 152 (e.g., a control board), as seen in FIG. 6. For example, it is envisioned that the central processor 152 may be in communication with the pump 104 to allow for pulse-width modulation control. Additionally, or alternatively, it is envisioned that the central processor 152 may be in communication with the various valves described above to regulate flow of the perfusion solution P through the system 1000 and, thus, the systolic and diastolic pressures in the cadaver 100. For example, the central processor 152 may be in communication with the valve 114 to move the valve 114 between the open and closed positions. It is also envisioned that the central processor 152 may be utilized to regulate operation of the air circuit 122 (e.g., by opening and closing the valves 140iA, 140iiA, 140iB, 140iiB), and/or that the central processor 152 may be utilized to provide linear voltage control of the apertured ball valve 146 in the venous circuit 106B to thereby regulate the central venous pressure.

The central processor 152 may also be in communication with the various sensors and meters included in the system 1000 (e.g., the pressure sensors 118i, 118ii, 118A, 118B, 118V, the flow meter(s) 120, etc.) to read and interpret data generated thereby to inform control over the system 1000. After processing the data, the processor 152 can then communicate control signals to the various components of the system 1000 (e.g., the valve 114, the valves 140, etc.) to achieve any desired result, such as homeostasis, or particular values for various parameters (e.g., stroke volume, systolic pressure, diastolic pressure, mean arterial pressure, pulse rate, pulse ratio, pulse pressure, flow rates for the perfusion solution P, etc.). These parameters can thus be configured via the communication of control signals to the various components of the system 1000. For example, it is envisioned that desired values for one or more of the parameters may be entered into a control device 154 (e.g., a cell phone, laptop, etc.) and communicated to the central processor 152 (e.g., via wireless communication). Operation of the system 1000 can then be varied accordingly by the central processor 152 (e.g., to adjust the frequency of the valve 114, the pressure within the system 1000, etc.).

During operation, it is envisioned that the system 1000 may run in a feedback loop to allow for constant measurement and evaluation of various parameters (e.g., based on data gathered from the various sensors and meters included in the system 1000). If it is determined that the system 1000 is operating within the desired parameters, then operation continues. However, if it is determined that the system 1000 is operating outside of the desired parameters, then the central processor 152 may be employed to vary operation, such as, for example, by changing the configuration of the pump 104, the timing of the valve 114 and/or the valves 142, 148, etc., until the desired result is achieved. The system 1000 thus allows for iterative adjustment in the various parameters to manipulate and/or maintain homeostasis.

In certain embodiments, it is also envisioned that the system 1000 may include software that is adapted to run educational scenarios during the training of medical professionals. In such embodiments, the software may be in communication with the various sensors and meters (e.g., the pressure sensors 118i, 118ii, 118A, 118B, 118V, the flow meter(s) 120, etc.) so as to generate and govern simulations. Additionally, it is envisioned that the software may generate post-simulation reports (e.g., for review and educational analysis).

With reference now to FIG. 6, use and operation of the system 1000 will be discussed. Initially, the cadaver 100 is prepared using a pre-wash solution (step 216), which inhibits (if not entirely prevents) clot formation in the cadaver 100. To increase the efficacy of the pre-wash solution, the pre-wash solution is administered as closely in time to death (e.g., euthanasia in the context of animal cadavers) as possible (e.g., via a transfer pump) to rid the cadaver 100 of native blood, fluids, etc.

In one particular implementation, the pre-wash solution includes: approximately 1.5 cups of salt; approximately 4 tabs (e.g., approximately 3 g to approximately 7 g) of potassium chloride; approximately ⅓ cup of baking soda; approximately ½ cup of corn syrup; approximately 5 tabs (e.g., approximately 50 g to approximately 75 g) of vitamin C; approximately 6 bottles (e.g., approximately 15 g to approximately 60 g) of magnesium citrate; approximately 12 packets (e.g., approximately 300 g to approximately 500 g) of gelatin; and approximately 50,000 units of heparin (or other such anticoagulant). It should be appreciated, however, that the ingredients and/or quantities described herein may be altered in additional embodiments of the present disclosure so as to vary the consistency, color, etc., of the pre-wash solution, and achieve any desired result. To assemble the pre-wash solution, each of the ingredients is mixed into boiling water, with the baking soda and the gelatin being added gradually, the mixture is continuously stirred, and additional water (e.g., approximately 15 L to approximately 25 L) is added until the desired consistency is achieved.

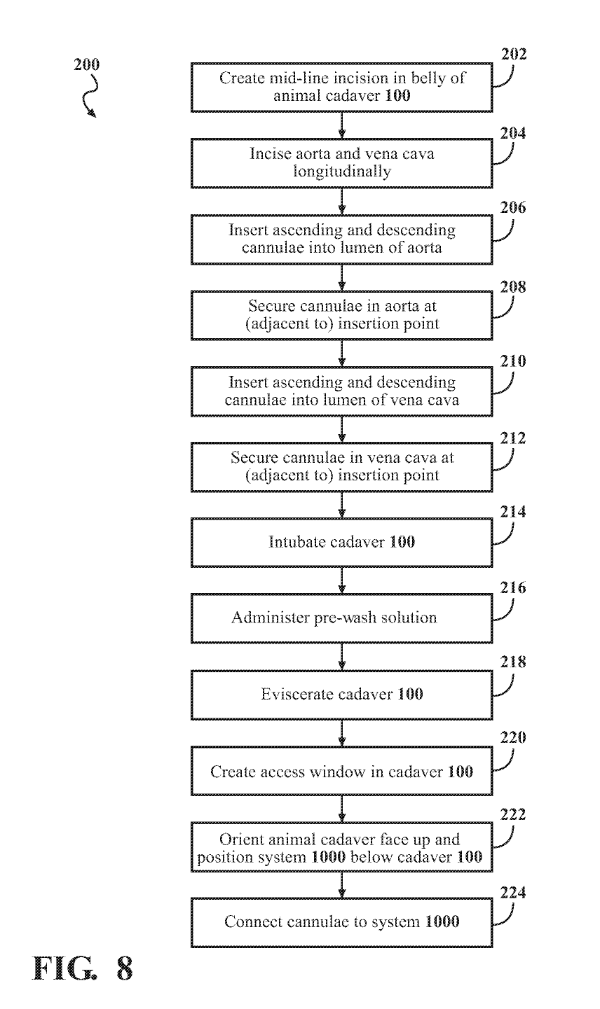

Either prior or subsequent to administration of the pre-wash solution, the cadaver 100 is surgically prepared using method 200 (FIG. 8). With respect to animal cadavers, a bypass cannulation system is utilized due to the inherent restrictions in animal physiology (e.g., relatively small size of the arteries, veins, etc.). To connect the cannulation system to the animal cadaver 100, a mid-line laparotomy is performed, in which an incision is made in the belly of the animal (step 202), and the aorta and inferior vena cava are exposed and incised longitudinally (along their lengths) (step 204). In order to facilitate circulation of the perfusion solution P to the upper and lower halves of the cadaver 100, ascending and descending cannulae (e.g., 10 mm cannulae) are inserted into both the aorta and the inferior vena cava (step 206). More specifically, individual ascending and descending cannulae are positioned in the lumen of the aorta, and the cannulae are secured in place at (or adjacent to) the insertion point (step 208), respectively, (e.g., using a surgeon's knot, a zip-tie, etc.). The process is then repeated to position and secure ascending and descending cannulae in the lumen of the inferior vena cava (steps 210, 212). Cannulate, and then pre-wash, Pre-wash done through cannulae to push out native blood and coat vessels with pre-wash solution. Time sensitive process in that it has to be done in this order.

During surgical preparation, the cadaver 100 is intubated (e.g., using an endotracheal tube and a bag, a ventilator, etc., that is connected to the endotracheal tube) (step 214) to re-inflate the lungs, and the endotracheal tube is tied-off to maintain inflation. It is envisioned that intubation may be performed at any suitable point in time, either prior or subsequent to cannulation.

Following cannulation, the cadaver 100 may be eviscerated (step 216) to create sufficient internal working space, avoid spoilage of the internal organs, and/or guard against contamination (e.g., by urine, feces, etc.). During evisceration, the major vessels are clamped off to restrict (if not entirely prevent) fluid flow therethrough, and the internal organs (e.g., the stomach, the intestines, the kidneys, the bladder, the liver, the reproductive organs, etc.) are removed as necessary. In certain implementations of the method 200, it is envisioned that the animal's heart may be left in place given its location above the cannulation site.

After evisceration, with the cadaver 100 face down, an access window is created by removing a section of the spine (and the surrounding tissue) (step 220). Thereafter, the cadaver 100 is oriented (face up) on an operating table, the system 1000 is positioned below the cadaver 100 (step 218), and the cannulae are fed through the access window for connection to the system 1000 (step 222). During use of the system 1000, the access window may also act as a drain port in the event that perfusion solution P (or other fluids) enter the internal cavity of the cadaver 100, in which case, the fluid(s) are allowed to exit the cadaver 100 through the access window.

Once the cadaver 100 is connected to the system 1000, the cadaver 100 can be sutured closed.

The surgical preparation procedure used in connection with human cadavers is similar, but somewhat different due to the presence of usable peripheral vessels, and the fact that human cadavers are generally pre-washed and prepared. As such, in the context of human cadavers, the surgical preparation procedure includes a washout (using the pre-wash solution) and cannulation only.

During cannulation, ascending and descending cannulae are inserted into appropriate peripheral vessels (e.g., the femoral or carotid artery, the jugular vein, etc.). More specifically, as discussed above in the context of animal cadavers, the aorta and inferior vena cava are exposed and incised longitudinally (along their lengths), and ascending and descending cannulae are positioned and secured in the appropriate vessels (e.g., the aorta and the jugular vein) to facilitate circulation of the perfusion solution P to the upper and lower halves of the cadaver 100.

The cadaver 100 is then intubated (in the manner discussed above), and the cadaver 100 is eviscerated to the extent required by the intended procedures. The need for the access window discussed above in the context of animal cadavers is obviated in human cadavers given the available access to the peripheral vessels.

In certain embodiments, it is envisioned that the cannulae utilized in preparation of the cadaver 100 (whether animal or human) may each include a ridge, a series of projections, or other such surface irregularities to create friction with the vessel(s) in which the cannulae are inserted to inhibit (if not entirely prevent) relative movement between the cannulae and the vessel(s).

Once the cadaver 100 is connected to the system 1000, the system 1000 can be utilized to replicate cardiovascular physiology and functionality in the cadaver 100. During operation, the perfusion solution P is pumped through the valve 114 into the cadaver 100 (via the pump 104), and the valve 114 is opened and closed to simulate a heartbeat in the cadaver 100, as well as systolic and diastolic pressure. In certain embodiments, it is envisioned that flow of the perfusion solution P into the cadaver 100 may be generally laminar so as to enable more accurate readings by the various sensors and meters described herein (e.g., the pressure sensors 118i, 118ii, 118A, 118B, 118V, the flow meter(s) 120, etc.). It should be appreciated, however, that the system 1000 may be configured to tolerate non-laminar flow of the perfusion solution P as well.

As the perfusion solution P is circulated through the system 1000, the air circuit 122 may be used to alter and modulate the systolic and diastolic pressure in the cadaver 100 so as to achieve a generally sinusoidal flow pattern, as seen in FIG. 4, rather than the generally square-shaped pattern seen in FIG. 3.

As discussed above, in certain embodiments, the perfusion solution P may be communicated into (and through) the venous circuit 106B prior to returning to the reservoir 102. In such embodiments, via modulation of the valve 142 (and/or the valve 148), central venous pressure can be simulated in the cadaver 100.

During operation of the system 1000, the various sensors and meters described herein (e.g., the pressure sensors 118i, 118ii, 118A, 118B, 118V, the flow meter(s) 120, etc.) may be used to monitor flow and pressure to facilitate various calculations, such as, for example, resistance, vascular pressure, fluid loss from the cadaver 100, etc. Additionally, the control system 150 (e.g., the central processor 152) may be utilized to vary operation of the components of the system 1000 (e.g., the valve 114 in the arterial circuit 106A, the valve 142 (and/or the valve 148) in the venous circuit 106B, the valves 140iA, 140iiA, 140iB, 140iiB in the air circuit 122, etc.) to achieve any desired results (e.g., homeostasis, particular values for various stroke volume, systolic pressure, diastolic pressure, mean arterial pressure, pulse rate, pulse ratio, pulse pressure, flow rates for the perfusion solution P, etc.). For example, it is envisioned that the aforementioned software may be utilized to execute simulation programs and/or facilitate the entry of any desired parameters.

Persons skilled in the art will understand that the various embodiments of the disclosure described herein and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately” and “generally” should be understood to encompass variations on the order of 25%, or to allow for manufacturing tolerances and/or deviations in design.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

1-16. (canceled)

17. A method of replicating cardiovascular functionality in a cadaver using a flow bypass system, the method comprising:
using a pump to circulate a perfusion solution through a closed circuit such that the perfusion solution flows from a reservoir into the cadaver, and from the cadaver into the reservoir, the perfusion solution being adapted to inhibit clot formation in the cadaver.

18. The method of claim 17, further including opening and closing a first valve positioned between the pump and the cadaver to simulate systolic pressure and diastolic pressure in the cadaver.

19. The method of claim 18, further including varying the systolic pressure via communication of the perfusion solution into and/or out of a first accumulator positioned between the pump and the first valve, and varying the diastolic pressure via communication of the perfusion solution into and/or out of a second accumulator positioned between the first valve and the cadaver.

20. The method of claim 18, further including opening and closing a second valve positioned between the cadaver and the reservoir to simulate central venous pressure in the cadaver.

21. The method of claim 20, wherein opening and closing the second valve includes moving the second valve between a fully open position and a fully closed position.

22. The method of claim 21, wherein opening and closing the second valve further includes moving the second valve into at least one partially open position.

23. The method of claim 21, wherein opening and closing the second valve includes rotating the second valve.

24. The method of claim 18, wherein using the pump includes wirelessly transmitting data to the flow bypass system from a control device.

25. The method of claim 24, wherein wirelessly transmitting data to the flow bypass system includes inputting one or more parameters achievable via opening and closing of the first valve.

26. The method of claim 18, further including collecting data from at least one sensor positioned downstream of the pump.

27. The method of claim 26, wherein collecting data from the at least one sensor includes:
collecting data from a first pressure sensor positioned upstream of the first valve; and
collecting data from a second pressure sensor positioned downstream of the first valve.

28. The method of claim 27, further including operating a feedback loop to allow for measurement and evaluation of one or more parameters of the flow bypass system based on data collected from the at least one sensor.

29. A method of replicating cardiovascular functionality in a cadaver using a flow bypass system, the method comprising:
using an arterial circuit to simulate systolic and diastolic pressure in the cadaver; and
using a venous circuit to simulate central venous pressure in the cadaver.

30. The method of claim 29, wherein using the arterial circuit includes:
using a pump to circulate a perfusion solution from a reservoir to the cadaver; and
regulating flow of the perfusion solution into the cadaver from the reservoir by opening and closing a first valve positioned downstream of the reservoir.

31. The method of claim 30, wherein using the venous circuit includes opening and closing a second valve positioned downstream of the first valve.

32. The method of claim 31, wherein opening and closing the first and second valves includes wirelessly transmitting data to the flow bypass system from a control device.

33. A method of replicating cardiovascular functionality in a cadaver using a flow bypass system, the method comprising:
circulating a perfusion solution through the cadaver using a closed circuit to simulate systolic pressure, diastolic pressure, and central venous pressure in the cadaver.

34. The method of claim 33, wherein simulating the systolic pressure and the diastolic pressure includes opening and closing a first valve positioned downstream of a pump configured to circulate the perfusion solution through the flow bypass system.

35. The method of claim 34, wherein simulating the central venous pressure includes opening and closing a second valve positioned downstream of the first valve, wherein closing the second valve restricts flow of the perfusion solution through the second valve to increase pressure between the cadaver and the second valve to thereby simulate an increase in the central venous pressure, and opening the second valve increases flow of the perfusion solution through the second valve to reduce pressure between the cadaver and the second valve to thereby simulate a decrease in the central venous pressure.

36. The method of claim 35, wherein circulating the perfusion solution through the cadaver includes wirelessly transmitting input data including at least one parameter to the flow bypass system from a control device, the at least one parameter being achievable via opening and closing of the first valve and/or the second valve.
